(19) United States
(12) Patent Application Publication
(10) Pub. No.: US 2002/0187701 A1
(43) Pub. Date: Dec. 12, 2002

(54) Filter media with enhanced stiffness and increased dust holding capacity

(75) Inventor: David Thomas Healey, Christiansburg, VA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: HOLLINGSWORTH & VOSE COMPANY, East Walpole, MA (US)

(21) Appl. No.: 10/135,797

(22) Filed: Apr. 30, 2002

Related U.S. Application Data
(60) Provisional application No. 60/288,048, filed on May 2, 2001.

(51) Int. Cl. D04H 3/16; D04H 1/56; B32B 5/26; D04H 13/00; D04H 5/00; D04H 3/00; D04H 1/00

(52) U.S. Cl. 442/382; 442/334; 442/340; 442/381; 442/400; 442/401

(57) ABSTRACT

A filter media having a high dust holding capacity and increased stiffness is provided. The filter media includes a middle filtering layer formed from at least one meltblown layer and having a dust entering side and a dust exiting side. A first outer layer is disposed on the dust entering side of the filter media and is formed from a meltblown polymer fiber web, and a second outer supporting layer, or backing, is disposed on the dust exiting side of the filter media, and is formed from a spunbond polymer fiber web and, optionally, a meltblown polymer fiber web. The filter media is particularly useful to form ASHRAE filters for applications including heating, refrigeration, and air conditioning filtration.

### CROSS REFERENCE TO RELATED APPLICATIONS

This application claims priority to U.S. Provisional Patent Application Serial No. 60/288,048, filed on May 2, 2001, entitled “Filter Media With Enhanced Stiffness and Increased Dust Holding Capacity,” which is expressly incorporated by reference herein.

### FIELD OF THE INVENTION

The present invention relates to a filter media for use in the ASHRAE market, and more particularly to a filter media having improved stiffness and increased dust holding capacities.

### BACKGROUND OF THE INVENTION

Paper filter media are commonly used for air filter applications such as heating, refrigeration, and air conditioning systems. Suitable filters and filter media for such applications are approved by the American Society of Heating, Refrigerating and Air-Conditioning Engineers, Inc. (ASHRAE), and most are referred to as ASHRAE filters or filter media.

In general, paper filter media comprise dense webs or mats of fibers that are used to form a filter, which is oriented in a gas stream carrying particulate material. The densely packed fine fibers of these webs provide fine interfiber pore structures that are highly suitable for mechanically trapping or screening of fine particles. The filter media are generally constructed to be permeable to the gas flow, and to also have a sufficiently fine pore size and appropriate porosity to inhibit the passage therethrough of particles greater than a selected size. As the gases pass through the filter media, the dust entering side of the filter media operates through diffusion and interception to capture and retain selected sized particles from the gas stream.

The paper filters are comparatively inexpensive, but can be ineffective in the removal of extremely fine dust and dirt particles. More problematic with such filter media is that they tend to become plugged with the trapped dirt. As the gases pass through the filter media, the filter is at least partially filled with particulates before the air pressure drop across the media wall increases to an unacceptable level.

Reduction of the porosity of the media can improve filtration performance of the media, but the effect is to increase the air pressure drop across the media. Additionally, reduced porosity of the filter media enables dirt particles to accumulate on the media surface at a faster rate than for a more porous filter, thereby causing a more rapid rate of increase in the pressure drop across the media. This phenomenon shortens the service life of the filter.

Moreover, some paper web filter media do not have a physical integrity that is sufficient enough to be self-supporting. Although the physical integrity of the filter media can be improved by increasing the basis weight or thickness thereof, the increased basis weight or thickness exacerbates the pressure drop across the filter media. As such, paper filter media are typically laminated to a supporting layer or fitted in a rigid frame. However, the conventional supporting layer or rigid frame generally does not contribute to the filtration process and only increases the production cost of the filter media.

Thus, there is a need for a filter media having a high dust holding capacity to reduce the amount of energy used and to extend the life of the filter. Moreover, there is a need for a filter media having an increased stiffness for improved handling and processability.

### SUMMARY OF THE INVENTION

The present invention provides a filter media having a high dust holding capacity and increased stiffness. The filter media is particularly useful for ASHRAE filtering applications, such as for use in heating, refrigeration, and air conditioning applications.

In one embodiment the filter media is formed from a multicomponent sheet having a meltblown upstream outer layer, a spunbond downstream outer layer, and a filtering component disposed between the upstream outer layer and the downstream outer layer. The filtering component is formed from at least one meltblown layer. The meltblown upstream outer layer can be textured to facilitate bonding on the layer to adjacent layers. In a preferred embodiment, the upstream outer layer is formed from a stiff, coarse meltblown polymeric material, and more preferably is formed from a non-woven polymer fiber web having randomly oriented fibers. The spunbond downstream outer layer can optionally include a meltblown layer adhered to the spunbond layer on a dust entering side of the spunbond downstream outer layer. The middle filtering layer preferably includes one or more layers of a meltblown polymer fiber web. In an exemplary embodiment, the filtering component, the upstream outer layer, and the downstream outer layer are formed from polypropylene.

In another embodiment, a multi-layer filter media is provided having a meltblown upstream outer layer, a spunbond downstream outer layer, and a filtering component disposed between the upstream outer layer and the downstream outer layer. The filtering component has a dust entering side and a dust exiting side, and is formed from a first coarse, high loft meltblown layer formed on a dust entering side of the filter component, a second coarse, stiff fiber meltblown layer formed on a dust exiting side of the filtering component, and a third fine fiber meltblown layer disposed between the first and second meltblown layers of the filtering component. The filter media is preferably used in applications requiring a filter efficiency level of about 80 to 85%, or about 90 to 95%.

In another embodiment according to the present invention, a multi-layer filter media is provided having a meltblown upstream outer layer, a spunbond downstream outer layer, and a filtering component disposed between the upstream outer layer and the downstream outer layer. The filtering components has a dust entering side and a dust exiting side, and includes a first and second layers. The first and second layers are each formed from a coarse, high loft meltblown polymer fiber. The filter media is preferably used in applications requiring a filter efficiency level of about 40 to 45%, or about 60 to 65%.

In another aspect, the invention relates to a method of manufacturing a filter media having an enhanced dust holding capacity and increased stiffness.

### BRIEF DESCRIPTION OF THE DRAWINGS

The invention will be more fully understood from the following detailed description taken in conjunction with the accompanying drawings, in which like reference numerals designate like parts throughout the various figures, and wherein:

FIG. 1 is a diagram illustrating a cross-sectional view of a filter media according to the present invention;

FIG. 2 is a diagram illustrating one embodiment of the filter media of FIG. 1; and

FIG. 3 is a diagram illustrating another embodiment of the filter media of FIG. 1.

### DETAILED DESCRIPTION OF THE INVENTION

The features and other details of the invention will now be more particularly described and pointed out in the claims. It will be understood that the particular embodiments of the invention are shown by way of illustration and not as limitations of the invention. The principle features of this invention can be employed in various embodiments without departing from the scope of the invention.

In general, the present invention provides filter media which retain particles, air borne contaminants, and/or oil. The filter media is particularly useful for ASHRAE filtering applications, including filters for use in heating and air conditioning ducts as bag filters or pleated panel filters. The filter media is also cost effective, has enhanced filtration performance characteristics and increased stiffness, and has improved handling and processability over current filter media.

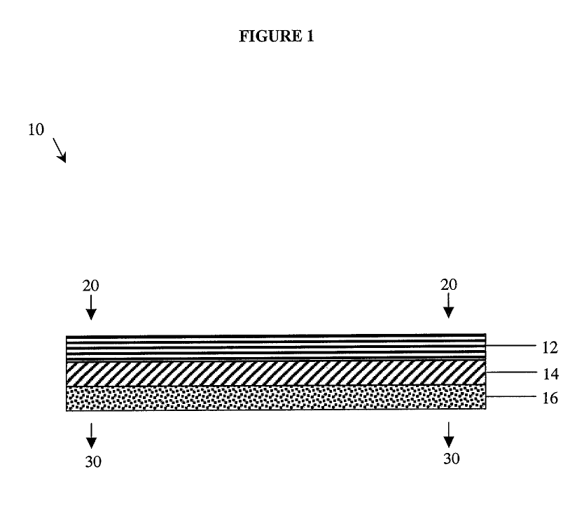

FIG. 1 illustrates one embodiment of a filter media 10 having a first outer layer 12 formed on a dust entering side 20 of the filter media 10, a middle filtering layer 14, and a second outer layer 16, or backing, formed on a dust exiting side 30 of the filter media 10. The first outer layer is preferably formed from a meltblown polymer fiber web, and it is effective to increase the dust holding capacity of and provide stiffness to the filter media 10. The second outer supporting layer 16 is preferably formed from a spunbond polymer fiber web, or a 2-ply combination layer having a meltblown polymer fiber web adhered to a spunbond polymer fiber web. The second outer layer is effective to add strength to the filter media 10, which can prevent rupture of the filter 10 during processing. The middle filtering component 14 serves as the primary filtering component of the filter media 10, and can be formed from one or several layers of fiber web.

The first outer layer 12 of the filter media 10 can be formed from a stiff, coarse meltblown fiber web, and is thereby effective to provide stiffness to the filter media 10 for a given pressure drop, and to increase the dust loading capacity of the filter media 10. In an exemplary embodiment, the first outer layer 12 is textured to facilitate adherence of the outer layer 12 to adjacent layers, namely the middle filtering layer 14. Meltblown fibers used to form the first outer layer 12 are known in the art, and generally include non-woven fibers formed from randomly oriented fibers made by entangling the fibers through mechanical means. The meltblown fiber web can have a relatively broad distribution of fiber diameters. The average fiber diameter of the polymer used to form the fiber web generally can be in the range of about 1 to 20 micrometers. Depending on the intended application, a more preferred polymer fiber diameter is in the range of about 1 to 15 micrometers, and more preferably about 5 to 10 micrometers. The basis weight of the first outer layer 12 is preferably in the range of about 10 to 50 grams/m², and more preferably is about 20 g/m². In use, the first outer layer 12 preferably has an air permeability greater than 800 cubic feet per minute in 0.5 inches of water.

Suitable materials which can be used to form the first meltblown outer layer 12 include polyolefins such as polyethylene, polypropylene, polyisobutylene, and ethylene-alpha-olefin copolymers; acrylic polymers and copolymers such as polyacrylate, polymethylmethacrylate, polyethylacrylate; vinyl halide polymers and copolymers such as polyvinyl chloride; polyvinyl ethers such as polyvinyl methyl ether; polyvinylidene halides, such as polyvinylidene fluoride and polyvinylidene chloride; polyacrylonitrile; polyvinyl ketones; polyvinyl amines; polyvinyl aromatics such as polystyrene; polyvinyl esters, such as polyvinyl acetate; copolymers of vinyl monomers with each other and olefins, such as ethylene-methyl methacrylate copolymers, acrylonitrile-styrene copolymers, ABS resins, and ethylene-vinyl acetate copolymers; natural and synthetic rubbers, including butadiene-styrene copolymers, polyisoprene, synthetic polyisoprene, polybutadiene, butadiene-acrylonitrile copolymers, polychloroprene rubbers, polyisobutylene rubber, ethylene-propylene rubber, ethylene-propylene-diene rubbers, isobutylene-isoprene copolymers, and polyurethane rubbers; polyamides such as Nylon 66 and polycaprolactam; polyesters, such as polyethylene terephthalate; polycarbonates; polyimides; polyethers; fluoropolymers such as polytetrafluoroethylene and fluorinated ethylenepropylene. Polypropylene is among the more preferred polymeric materials.

The second outer layer 16 is preferably formed from a spunbond fiber web disposed on the dust exiting side 30 of the filter media 10. The use of a spunbond fiber web provides added strength and stiffness to the filter media 10. The second outer layer 16 can optionally be formed from a 2-ply combination layer having a meltblown fiber web adhered to a spunbond fiber web. The 2-ply combination layer can be formed by meltblowing a very coarse fiber directly onto a spunbond fiber web. The meltblown fibers are preferably formed from a stiff polymeric material, similar to the materials described with respect to the first outer layer 12, and are effective to provide stiffness to the filter material 10. The meltblown fiber web layer is further advantageous in that it adds uniformity to the spunbond layer to eliminate any areas where light fiber coverage may exist. The spunbond fibers can be formed from a light polymeric material, and are also effective to provide strength to the filter material 10.

Spunbond webs are typically characterized by a relatively high strength/weight ratio and high porosity, and have good abrasion resistance properties. The average fiber diameter can be in the range of about 8 to 13 micrometers, and is preferably about 10 micrometers. The basis weight of the second outer layer 16 is preferably in the range of about 8 to 40 g/m², and more preferably is about 15.3 g/m². However, the basis weight of the second outer layer 16 can vary depending upon the strength requirements of a given filtering application, and considerably heavier spunbond layers can be used. One of ordinary skill in the art can readily determine the suitable basis weight, considering factors such as the desired level of strength during manufacture or use, intended filter efficiency and permissible levels of resistance or pressure drop. In general, the spunbond layer is a relatively thin layer of coarse fibers that primarily serves a structural function, and is to contribute little or nothing to either filtration or pressure drop in the completed filter media.

Suitable spunbond materials from which the outer layer 16 can be made are well known to those of ordinary skill in the art. For example, the spunbond fibers can be prepared from various polymer resins, including but not limited to, polyolefins such as polyethylene, polypropylene, polyisobutylene, and ethylene-alpha-olefin copolymers; acrylic polymers and copolymers such as polyacrylate, polymethylmethacrylate, polyethylacrylate; vinyl halide polymers and copolymers such as polyvinyl chloride; polyvinyl ethers such as polyvinyl methyl ether; polyvinylidene halides, such as polyvinylidene fluoride and polyvinylidene chloride; polyacrylonitrile; polyvinyl ketones; polyvinyl amines; polyvinyl aromatics such as polystyrene; polyvinyl esters, such as polyvinyl acetate; copolymers of vinyl monomers with each other and olefins, such as ethylene-methyl methacrylate copolymers, acrylonitrile-styrene copolymers, ABS resins, and ethylene-vinyl acetate copolymers; natural and synthetic rubbers, including butadiene-styrene copolymers, polyisoprene, synthetic polyisoprene, polybutadiene, butadiene-acrylonitrile copolymers, polychloroprene rubbers, polyisobutylene rubber, ethylene-propylene rubber, ethylene-propylene-diene rubbers, isobutylene-isoprene copolymers, and polyurethane rubbers; polyamides such as Nylon 66 and polycaprolactam; polyesters, such as polyethylene terephthalate; polycarbonates; polyimides; polyethers; fluoropolymers such as polytetrafluoroethylene and fluorinated ethylenepropylene.

An example of a suitable commercially available spunbond material for use in the outer layer 16 is the polypropylene spunbond material provided by Reemay, Inc., which is a member of BBA Nonwovens, having a basis weight of about 15.3 g/m² (0.45 ounces/y²).

The filtering component 14, which is disposed between the first and second outer layers 12, 16, is effective to provide filtration and can be formed from one up to several layers of fiber web. The layers 14 can range from coarse, high loft fibers, to fine microfibers, and can have a web basis weight ranging from about 10 to 60 g/m². The properties of each layer are dependent on manufacturing practice and polymer type. Thus, the processing parameters can be adjusted to produce one or more meltblown layers having the desired properties. The number of layers, and the type of material, used to form the filtering component 14 can be determined based on the efficiency level required for use. Filters having a high efficiency level will prevent more particles from passing through the filter compared to filters having lower efficiency levels. In general, filters used in the ASHRAE market typically have an efficiency level of either 40-45%, 60-65%, 80-85%, or 90-95%. A person having ordinary skill in the art will readily appreciate that a variety of different layers known in the art can be used to achieve the desired efficiency.

The meltblown material used to form the filtering component 14 of the filter media 10, 40, 50 according to the present invention can be made from a variety of polymeric materials, including those described with respect to the first outer layer 12. The fibers preferably have a relatively broad fiber diameter distribution, the average fiber diameter of the polymer used being in the range of about 0.5 to 20 micrometers. Depending on the intended application, a more preferred average polymer fiber diameter is in the range of about 1 to 15 micrometers, more preferably about 2 to 4 micrometers. The total thickness of the filtering component 14 can be between about 20 and 100 mils, and is preferably between about 30 and 50 mils.

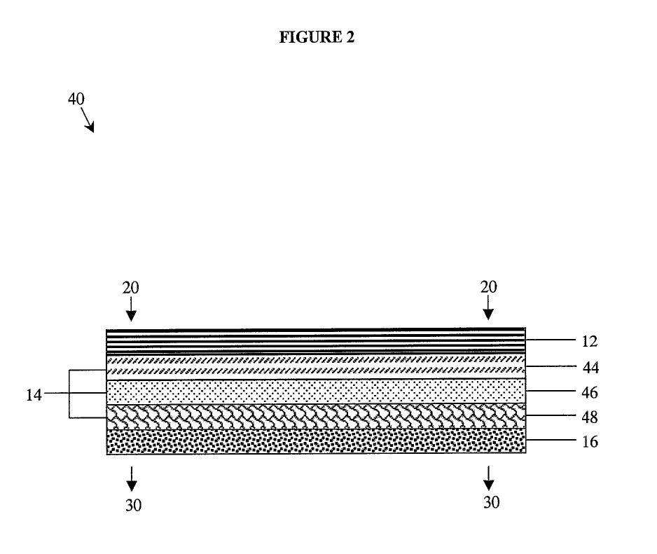

By way of non-limiting example, FIG. 2 illustrates a filter media 40 for use in applications requiring an efficiency level of either 80-85% or 90-95%. The filter media 40 includes first and second outer layers 12, 16 as previously described, and a filtering component 14 formed from three meltblown layers 44, 46, 48. The first meltblown filtering component 44, which is disposed immediately downstream from the first outer layer 12, is formed from a coarse, high loft meltblown polymer fiber web, and serves as a pre-filter, catching and retaining the largest particles from the air stream being filtered. The first layer 44 prevents the larger particles in the air stream from closing the smaller voids in the second and third filtering components 46, 48. The web basis weight of layer 44 is preferably in the range of about 35 to 75 g/m², and more preferably is about 50 g/m². The second filtering component 46 is formed from a fine fiber meltblown web, and is effective to retain smaller particles not trapped by the first layer 44, thereby increasing the dust holding capacity of the filter media 40. The web basis weight of layer 46 is preferably in the range of about 20 to 60 g/m², and more preferably is about 30 g/m². The third filtering component 48 is formed from a very coarse, stiff fiber meltblown web, which provides strength and stiffness to the filter media 40. The web basis weight of layer 48 is preferably in the range of about 10 to 50 g/m², and more preferably is about 30 g/m².

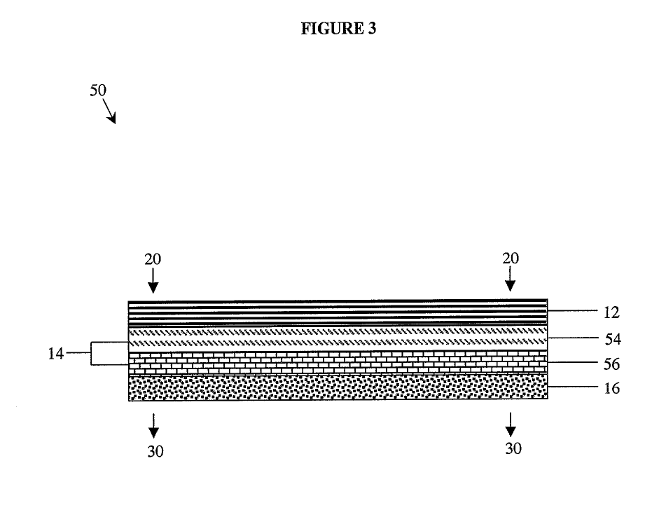

FIG. 3 illustrates another embodiment of a filter media 50 useful for ASHRAE filtering applications requiring an efficiency level of either 40-45% or 60-65%. The filter media 50 includes first and second outer layers 12, 16 as previously described, and a filtering component 14 formed from two meltblown layers 54, 56. The first and second meltblown filtering components 54, 56 are each formed from a coarse, high loft meltblown polymer fiber web, and are effective to trap and retain particles from the air stream being filtered. The web basis weight of each layer 54, 56 is preferably in the range of about 20 to 50 g/m², and more preferably is about 30 g/m².

A person having ordinary skill in the art will appreciate that additional layers of each material used to form the filter media according to the present invention can be included, and additional materials can also be used as a substitute or in addition to the materials disclosed herein. Moreover, the filter media can optionally include various additives conventionally used in such materials to impart special properties, facilitate extrusion or otherwise improve performance of the material.

One suitable additive useful in the filter media according to the present invention is a charge stabilizing additive. Examples of charge stabilizing additives include fatty acid amides derived from fatty acids. The term “fatty acid” is recognized by those having ordinary skill in the art and it is intended to include those saturated or unsaturated straight chain carboxylic acids obtained from the hydrolysis of fats. Examples of suitable fatty acids include lauric acid (dodecanoic acid), myristic acid (tetradecanoic acid), palmitic acid (hexadecanoic acid), stearic acid (octadecanoic acid), oleic acid ((Z)-9-octadecenoic acid), linoleic acid ((Z,Z)-9,12-octadecadienoic acid), linolenic acid ((Z,Z,Z)-9,12,15-octadecatrienoic acid) and eleostearic acid (Z,E,E)-9,11,13-octadecatrienoic acid). Typically the amides formed from the above referenced acids are primary amides which are prepared by methods well known in the art. Secondary and tertiary fatty acid amides can also be suitable as charge stabilizing agents wherein the amide nitrogen is substituted with one or more alkyl groups. Secondary and tertiary fatty acid amides can also be prepared by methods well known in the art, such as by esterification of a fatty acid followed by an amidation reaction with a suitable alkylamine. The alkyl substituents on the amide nitrogen can be straight chain or branched chain alkyl groups and can have between about two and twenty carbon atoms, inclusive, preferably between about two and 14 carbon atoms, inclusive, more preferably between about two and six carbon atoms, inclusive, most preferably about two carbon atoms. In a preferred embodiment, the fatty acid amide can be a “bis” amide wherein an alkyl chain tethers two nitrogens of two independent amide molecules. For example, alkylene bis-fatty acid amides include alkylene bis-stearamides, alkylene bis-palmitamides, alkylene bis-myristamides and alkylene bis-lauramides. Typically the alkyl chain tether includes between about 2 and 8 carbon atoms, inclusive, preferably 2 carbon atoms. The alkyl chain tether can be branched or unbranched. Preferred bis fatty acid amides include ethylene bis-stearamides and ethylene bis-palmitamides such as N,N′-ethylenebistearamide and N,N′-ethylenebispalmitamide.

To prepare filter media 10, 40, 50 according to the present invention, meltblown and spunbond processes known in the art can be used.

By way of non-limiting example, the meltblown process used to form the first outer layer 12 and the filtering component 14 involves extruding a molten thermoplastic polymer through a plurality of fine, usually circular, die capillaries as molten threads or filaments into a high velocity gas stream which attenuates the filaments of molten thermoplastic polymer to reduce their diameter. The flow rate and pressure of the attenuating gas stream can be adjusted to form continuous melt blown filaments or discontinuous fibers. The formed air-borne fibers, which are not fully quenched, are carried by the high velocity gas stream and deposited on a collecting surface to form a web of randomly dispersed and autogenously bonded melt blown fibers. In an exemplary embodiment, the first outer layer 12 can be texturized by blowing the fibers onto a collecting surface having a pattern formed thereon.

The nature of webs formed by the meltblown process may be varied by adjustment of the processing parameters, such as the blowing air temperature, velocity, and direction. These parameters affect individual fiber length, diameter, and physical properties. Other important factors are orifice geometry and the distance between the die assembly and the collection surface.

Exemplary processes for producing meltblown fiber webs are disclosed in U.S. Pat. Nos. 3,849,241 to Butin et al., and 4,380,570 to Schwarz.

The spunbond polymer web used to form the second outer layer 16 can be formed by extruding one or more molten thermoplastic polymers as fibers from a plurality of capillaries of a spinneret. The extruded fibers are cooled while being drawn by an eductive or other well-known drawing mechanism to form spunbond fibers. The drawn spunbond fibers are then deposited or laid onto a forming surface in a random manner to form a loosely entangled and uniform fiber web. The laid fiber web is then subjected to a bonding process, such as thermobonding or by needlepunching, to impart physical integrity and dimensional stability to the resulting nonwoven fiber web.

Exemplary processes for producing spunbond nonwoven webs are disclosed, for example, in U.S. Pat. Nos. 4,340,563 to Appel et al., 3,802,817 to Matsuki et al., 3,855,046 to Hansen et al., and 3,692,618 to Dorschener et al.

Once the spunbond and meltblown layers are formed, the layers are bonded to form the filter media 10, 40, 50 according to the present invention. Several processes known in the art can be used to form the filter media 10, 40, 50, such as ultrasonic welding, ultrasonic bonding, adhesives or other methods known to those having ordinary skill in the art. Ultrasonic bonding can be accomplished by edge welding, full width bonding, partial width bonding, or combinations thereof.

Alternatively, the layers can be pressed together by a calendering process which causes each layer to physically adhere to the other layer. This provides the advantage that a bonding agent is not incorporated into the filter media 10, 40, 50 and thus does not effect the porosity of the filter media 10, 40, 50.

Following or during formation of the filter media 10, 40, 50, the fiber web can optionally be imparted with an electrostatic charge for enhancing performance of the filter media 10, 40, 50. A variety of techniques are well known to impart a permanent dipole to the polymer web in order to form electret filter media. Charging can be effected through the use of AC or DC corona discharge units and combinations thereof. The corona unit(s), AC corona discharge unit(s) and/or DC corona discharge unit(s) can be placed above and/or below a fiber web to impart electret properties to the fiber web. Configurations include placement of a neutrally grounded roll(s) on either side of the fiber web and the active electrode(s) above or below either side of the web. In certain embodiments, only one type of corona discharge unit, e.g., a DC or an AC corona discharge unit, is placed above, below or in an alternating arrangement above and below the fiber web. In other embodiments alternating AC or DC corona discharge units can be used in combination. The AC or DC corona discharge unit can be controlled so that only positive or negative ions are generated. The particular characteristics of the discharge are determined by the shape of the electrodes, the polarity, the size of the gap, and the gas or gas mixture.

An example of a process for producing electret properties in fiber webs can be found in U.S. Pat. No. 5,401,446, the contents of which are incorporated herein by reference. Charging can also be accomplished using other techniques, including friction-based charging techniques. Typically the fiber web is subjected to a discharge of between about 1 to about 30 kV(energy type, e.g., DC discharge or AC discharge)/cm, preferably between about 10 kV/cm and about 30 kV/cm, with a preferred range of between about 10 to about 20 kV/cm.

A person having ordinary skill in the art will readily appreciate that filter efficiency and properties of the electret filter media of the invention can also be optimized through additional processing techniques.

In use, filter performance is evaluated based on different criteria. It is desirable that filters, or filter media, be characterized by low penetration across the filter of contaminants to be filtered. At the same time, however, there should exist a relatively low pressure drop, or resistance, across the filter.

The filter media of the present invention, therefore, provide efficiencies of filtration for air borne contaminants of 40-45%, 60-65%, 80-85% and 90-95%, with a dust holding capacity of about 8.0 g/m². This is a significant improvement over current products which have similar efficiencies, but which have dust holding capacities between about 4.0 and 7.0 g/m².

The filter media according to the present invention may be utilized in a wide variety of air filter applications, and are particularly suitable for use in ASHRAE filters. Thus, for example, the filter media may be used to form HVAC, HEPA, ULPA or similar filters. In some instances, media according to the present invention may be utilized to enhance the operation of other media, such as other types of commercially available filter media. Thus, media according to the present invention may be applied to the upstream side, downstream side, or between layers of various filter media to achieve preferred filter operation.

The following examples serve to further described the invention.

### EXAMPLE 1

The resulting five layer electret filter media was prepared as described above, wherein the first outer layer (gas entry side) was formed from a 20 g/m² coarse fiber, stiff polypropylene meltblown, the filtering component was formed from two layers, the first (upstream) layer being a 50 g/m² coarse fiber, high loft polypropylene meltblown, and the second (downstream) layer being a 30 g/m² fine fiber polypropylene meltblown. The second outer layer (gas exit side) was formed from a 30 g/m² coarse fiber, stiff polypropylene meltblown layer combined with a 15.3 g/m² light polypropylene spunbond layer.

### COMPARATIVE EXAMPLE 1

A first comparative example was processed from four layers of fiber web. The first outer layer (gas entry side) was formed from an 8.5 g/m² light polypropylene spunbond. The filtering component was formed from two layers of fiber web, the first (upstream) layer being a 67 g/m² coarse fiber, high loft polypropylene meltblown, and the second (downstream) layer being a 45 g/m² fine fiber polypropylene meltblown. The second outer layer (gas exit side) was formed from a 15.3 g/m2 moderate weight polypropylene spunbond.

### COMPARATIVE EXAMPLE 2

A second comparative example was processed from four layers of fiber web. The first outer layer (gas entry side) was formed from a 90 g/m² high loft, polyester carded nonwoven fiber web. The filtering component was formed a first (upstream) layer of a 30 g/m² coarse fiber, high loft polypropylene meltblown, and a second (downstream) layer of a 30 g/m² fine fiber polypropylene meltblown. The second outer layer (gas exit side) was formed from a 15.3 g/m² polypropylene spunbond.

### COMPARATIVE EXAMPLE 3

A third comparative example was processed from four layers of fiber web. The first outer layer (gas entry side) was formed from an 8.5 g/m² polypropylene spunbond. The filtering component was formed from two layers of fiber web, the first (upstream) layer being a 67 g/m² coarse fiber, high loft polypropylene meltblown, and the second (downstream) layer being a 45 g/m² fine fiber polypropylene meltblown. The second outer layer (gas exit side) was formed from a 42.5 g/m² polypropylene Typar®.

The following table illustrates the properties of one embodiment of the filter media according to the present invention, as prepared according to Example 1, compared to current filter media prepared according to Comparative Examples 1, 2, and 3.

TABLE 1

| | | | COMPARATIVE | | COMPARATIVE | | COMPARATIVE | |
|---|---|---|---|---|---|---|---|---|
| | EXAMPLE 1 | | EXAMPLE 1 | | EXAMPLE 2 | | EXAMPLE 3 | |
| Basis Weight | 145.3 | g/m² | 135.8 | g/m² | 165.3 | g/m² | 163 | g/m² |
| Thickness | 65 | mils | 60 | mils | 110 | mils | 65 | mils |
| Air Flow Resistance | 0.5 | mmH₂O | 0.5 | mmH₂O | 0.5 | mmH₂O | 0.5 | mmH₂O |
| at 40% efficiency | | | | | | | | |
| Air Flow Resistance | 0.7 | mmH₂O | 0.7 | mmH₂O | 0.7 | mmH₂O | 0.7 | mmH₂O |
| at 60% efficiency | | | | | | | | |
| Air Flow Resistance | 1.5 | mmH₂O | 1.5 | mmH₂O | 1.5 | mmH₂O | 1.5 | mmH₂O |
| at 80% efficiency | | | | | | | | |
| Air Flow Resistance | 2.5 | mmH₂O | 2.5 | mmH₂O | 2.5 | mmH₂O | 2.5 | mmH₂O |
| at 0% efficiency | | | | | | | | |
| NaCl Penetration at | 45% | | 45% | | 45% | | 45% | |
| 40% efficiency | | | | | | | | |
| NaCl Penetration at | 25% | | 25% | | 25% | | 25% | |
| 60% efficiency | | | | | | | | |
| NaCl Penetration at | 8% | | 8% | | 8% | | 8% | |
| 80% efficiency | | | | | | | | |
| NaCl Penetration at | 2.5% | | 2.5% | | 2.5% | | 2.5% | |
| 90% efficiency | | | | | | | | |
| Dust Holding | 8.0 | g/ft² | 4.6 | g/ft² | 7.0 | g/ft² | 4.6 | g/ft² |
| Capacity | | | | | | | | |

Those having ordinary skill in the art will know, or be able to ascertain, using no more than routine experimentation, many equivalents to the specific embodiments of the invention described herein. These and all other equivalents are intended to be encompassed by the following claims. All publications and references cited herein including those in the background section are expressly incorporated herein by reference in their entirety.

What is claimed is:

1. A filter media formed from a multicomponent sheet, the filter media comprising:
a meltblown upstream outer layer;
a spunbond downstream outer layer; and
a filtering component disposed between the upstream outer layer and the downstream outer layer, the filtering component being formed from at least one meltblown layer.

2. The filter media of claim 1, wherein the upstream outer layer is formed from a stiff, coarse meltblown polymeric material.

3. The filter media of claim 1, wherein the meltblown upstream outer layer is textured.

4. The filter media of claim 1, wherein the meltblown upstream outer layer has an air permeability above about 800 cubic feet per minute in 0.5 inches of water.

5. The filter media of claim 1, wherein the upstream outer layer is formed from a non-woven polymer fiber web having randomly oriented fibers.

6. The filter media of claim 1, wherein the upstream outer layer is formed from fibers having a diameter in the range of about 1 to 20 micrometers.

7. The filter media of claim 1, wherein the upstream outer layer has a web basis weight in the range of about 10 to 50 grams/m².

8. The filter media of claim 7, wherein the web basis weight is about 20 grams/m².

9. The filter media of claim 1, wherein the spunbond downstream outer layer further includes a meltblown layer adhered to the spunbond layer on a dust entering side of the spunbond downstream outer layer.

10. The filter media of claim 1, wherein the spunbond downstream outer layer is formed from fibers having a diameter in the range of about 8 to 13 micrometers.

11. The filter media of claim 1, wherein the spunbond downstream outer layer has a web basis weight in the range of about 8 to 40 grams/m².

12. The filter media of claim 11, wherein the web basis weight is about 15.3 grams/m².

13. The filter media of claim 1, wherein the middle filtering layer comprises one or more layers of a meltblown polymer fiber web.

14. The filter media of claim 13, wherein each layer of the middle filtering layer has a web basis weight in the range of about 10 to 60 grams/m².

15. The filter media of claim 13, wherein the middle filtering layer is formed from fibers having a diameter in the range of about 0.5 to 20 micrometers.

16. The filter media of claim 13, wherein the middle filtering layer has a thickness in the range of about 20 to 100 mils.

17. The filter media of claim 13, wherein the middle filtering layer has a thickness in the range of about 30 to 50 mils.

18. The filter media of claim 1, wherein the upstream outer layer, the downstream outer layer, and the middle filtering component are each formed from polymers selected from the group consisting of polyolefins, acrylic polymers and copolymers, vinyl halide polymers and copolymers, polyvinyl ethers, polyvinylidene halides, polyacrylonitrile, polyvinyl ketones, polyvinyl amines, polyvinyl aromatics, polyvinyl esters, copolymers of vinyl monomers, natural and synthetic rubbers, polyamides, polyesters, polycarbonates, polyimides, polyethers, fluoropolymers, and mixtures thereof.

19. The filter media of claim 1, wherein the filtering component, the upstream outer layer, and the downstream outer layer are formed from polypropylene.

20. The filter media of claim 1, wherein the filter media has a dust holding capacity of about 8.0 grams/m².

21. The filter media of claim 1, wherein the filter media comprises an electret.

22. A multi-layer filter media, comprising:
a meltblown upstream outer layer;
a spunbond downstream outer layer; and
a filtering component disposed between the upstream outer layer and the downstream outer layer and having a dust entering side and a dust exiting side, the filtering component comprising
a first coarse, high loft meltblown layer formed on a dust entering side of the filter component;
a second coarse, stiff fiber meltblown layer formed on a dust exiting side of the filtering component; and
a third fine fiber meltblown layer disposed between the first and second meltblown layers of the filtering component.

23. The multi-layer filter media of claim 22, wherein:
the first coarse, high loft meltblown layer of the filtering component has a web basis weight in the range of about 35 to 75 grams/m²;
the second coarse, stiff fiber meltblown layer of the filtering component has a web basis weight in the range of about 10 to 50 grams/m²; and
the third fine fiber meltblown layer of the filtering component has a web basis weight in the range of about 20 to 60 grams/m².

24. The filter media of claim 23, wherein the filter media is effective for use in applications requiring a filter efficiency level of about 80 to 85%.

25. The filter media of claim 23, wherein the filter media is effective for use in applications requiring a filter efficiency level of about 90 to 95%.

26. A multi-layer filter media, comprising:
a meltblown upstream outer layer;
a spunbond downstream outer layer; and
a filtering component disposed between the upstream outer layer and the downstream outer layer and having a dust entering side and a dust exiting side, the filtering component comprising first and second layers, each layer being formed from a coarse, high loft meltblown polymer fiber.

27. The filter media of 26, wherein the first and second layers of the filtering component each have a web basis weight in the range of about 20 to 50 grams/m².

28. The filter media of claim 27, wherein the filter media is effective for use in applications requiring a filter efficiency level of about 40 to 45%.

29. The filter media of claim 27, wherein the filter media is effective for use in applications requiring a filter efficiency level of about 60 to 65%.

30. A method for manufacturing a filter media, comprising the steps of:
providing a downstream outer backing layer formed from a spunbond polymeric material;
meltblowing onto the downstream outer backing layer at least one layer of a filtering component; and
meltblowing onto the at least one layer of the filtering component an upstream outer layer formed from a meltblown polymeric material.

31. The method of claim 30, further comprising the step of treating the filter media to form substantially permanent charge pairs.
